(19) United States
(12) Patent Application Publication
(10) Pub. No.: US 2018/0063296 A1
(43) Pub. Date: Mar. 1, 2018

(54) DATA-DIVISION CONTROL METHOD, COMMUNICATION SYSTEM, AND COMMUNICATION APPARATUS

(71) Applicant: Fujitsu Limited, Kawasaki-shi (JP)

(72) Inventor: Hideo KATO, Kawasaki (JP)

(73) Assignee: Fujitsu Limited, Kawasaki-shi (JP)

(21) Appl. No.: 15/676,548

(22) Filed: Aug. 14, 2017

(30) Foreign Application Priority Data
Aug. 29, 2016 (JP) 2016-166475

(51) Int. Cl. H04L 29/06; H04L 12/947; H04L 12/741

(52) U.S. Cl. CPC H04L 69/22; H04L 45/74; H04L 49/25

(57) ABSTRACT

A data-division control method executed by a communication system includes generating, by a first processor included in a first communication apparatus, a plurality of divided data by dividing transmission data to be transmitted; generating a plurality of frames including the plurality of divided data by adjusting a length of a payload in which each of the plurality of divided data is stored, in accordance with condition information in which payload lengths and an order of divided data are associated with each other; transmitting the plurality of frames to a second communication apparatus by using a first path and a second path; extracting, by a second processor included in the second communication apparatus, information about a payload length from a header of each of the frames; and identifying an order of the plurality of divided data included in the plurality of frames, by using the extracted information and the condition information.

### CROSS-REFERENCE TO RELATED APPLICATION

This application is based upon and claims the benefit of priority of the prior Japanese Patent Application No. 2016-166475, filed on Aug. 29, 2016, the entire contents of which are incorporated herein by reference.

### FIELD

The embodiment discussed herein is related to a data-division control method, a communication system, and a communication apparatus.

### BACKGROUND

With an increase in the amount of data transmitted/received between communication apparatuses, communication may be performed using a plurality of paths in parallel. There are also cases in which one piece of data is divided into a plurality of pieces of data, which are transmitted using a plurality of frames. When communication using a plurality of paths is performed to transmit the pieces of divided data by using the plurality of frames, there are cases in which the order of the pieces of divided data changes when they arrive at a communication apparatus at a receiving end.

FIG. 1 is a diagram illustrating an example of data division transmission. In the example illustrated in FIG. 1, a communication apparatus at a transmitting end that transmits data is referred to as a “transmitting apparatus 2”, and a communication apparatus that receives data is referred to as a “receiving apparatus 4”. The transmitting apparatus 2 and the receiving apparatus 4 perform communication by using both a 0-system path and a 1-system path. For example, the transmitting apparatus 2 transmits data D1 to the receiving apparatus 4. For the transmission of the data D1, the transmitting apparatus 2 divides the data D1 into pieces of divided data d1 to d5.

Sequence SE1 in FIG. 1 illustrates an example in which frames including the pieces of divided data d1 to d5 are transmitted and received. The transmitting apparatus 2 transmits the divided data d1 and d2 through the 0-system path and then transmits the divided data d3 to d5 through the 1-system path. In this case, the amount of data transferred through the 0-system path is larger than the amount of data transferred through the 1-system path. Thus, the amount of time taken for the frames transmitted from the transmitting apparatus 2 through the 0-system path to arrive at the receiving apparatus 4 is larger than the amount of time taken for the frames transmitted from the transmitting apparatus 2 through the 1-system path to arrive at the receiving apparatus 4. Thus, even when the divided data d1 to d5 are transmitted from the transmitting apparatus 2 in the order d1, d2, d3, d4, and d5, the transmitted divided data d1 to d5 may arrive at the receiving apparatus 4 in the order d1, d3, d2, d4, and d5. That is, there is a possibility that order reversal occurs. Therefore, the receiving apparatus 4 identifies the order of pieces of data in respective frames by using information in payloads. The receiving apparatus 4 then performs processing for rearranging the pieces of divided data in correct order. For example, when IP packets are included in the frames, the receiving apparatus 4 may use information of flags, fragment offsets, and so on in the packets.

As a related technology, there has been proposed a method in which input data is divided into data packets, data packets including a transmission order are made redundant, and the data packets are transmitted in different transmission orders for respective redundant paths to a receiving apparatus (for example, Japanese Laid-open Patent Publication No. 2015-097349).

In an apparatus that receives frames, there are cases in which order reversal occurs. Thus, the apparatus that receives frames analyzes information in payloads included in the frames and rearranges the order of pieces of data in the frames, as appropriate. Hence, before performing processing on the data by using application software or the like, the apparatus at the receiving end also performs processing on the payloads in order for the apparatus at the receiving end to rearrange the order of the pieces of data in the frames. As a result, the amount of processing load in the apparatus at the receiving end increases. In view of the foregoing, it is desirable to be able to reduce the amount of processing load on the communication apparatus.

### SUMMARY

According to an aspect of the invention, a data-division control method executed by a communication system including a first communication apparatus and a second communication apparatus coupled with the first communication apparatus through a first path and a second path, the data-division control method includes generating, by a first processor included in the first communication apparatus, a plurality of divided data by dividing transmission data to be transmitted; generating a plurality frames including the plurality of divided data by adjusting a length of a payload in which each of the plurality of divided data is stored, in accordance with condition information in which payload lengths and an order of divided data are associated with each other, each of the first communication apparatus and the second communication apparatus including a memory configured to store the condition information; transmitting the plurality of frames to the second communication apparatus by using the first path and the second path; extracting, by a second processor included in the second communication apparatus, information about a payload length from a header of each of the frames; and identifying an order of the plurality of divided data included in the plurality of frames, by using the extracted information about the payload length and the condition information that is stored in the memory included in the second communication apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of data division transmission;

FIG. 2 is a sequence diagram illustrating an example of a communication method according to an embodiment;

FIG. 3 is a diagram illustrating an example of the configuration of a communication apparatus;

FIG. 4 is a diagram illustrating an example of the hardware configuration of apparatuses in a system;

FIG. 5 is a diagram illustrating an example of the format of a frame;

FIG. 6 is a diagram illustrating an example of data division processing;

FIG. 7 is a flowchart illustrating an example of data transmission processing;

FIG. 8 illustrates an example of storage regions of divided data;

FIG. 9 is a flowchart illustrating an example of divided-data storage processing;

FIGS. 10A and 10B are flowcharts illustrating an example of the divided-data storage processing;

FIG. 11 is a flowchart illustrating an example of divided-data read processing;

FIG. 12 is a sequence diagram illustrating an example of communication processing;

FIG. 13 is a diagram illustrating comparison between the method according to the embodiment and switching processing involving checking the reception status;

FIGS. 14A and 14B are diagrams illustrating comparison between the method according to the embodiment and a method for performing read processing after performing reordering;

FIG. 15 is a diagram for describing an example when a frame length is adjusted using padding; and

FIG. 16 is a diagram illustrating an example of a communication system.

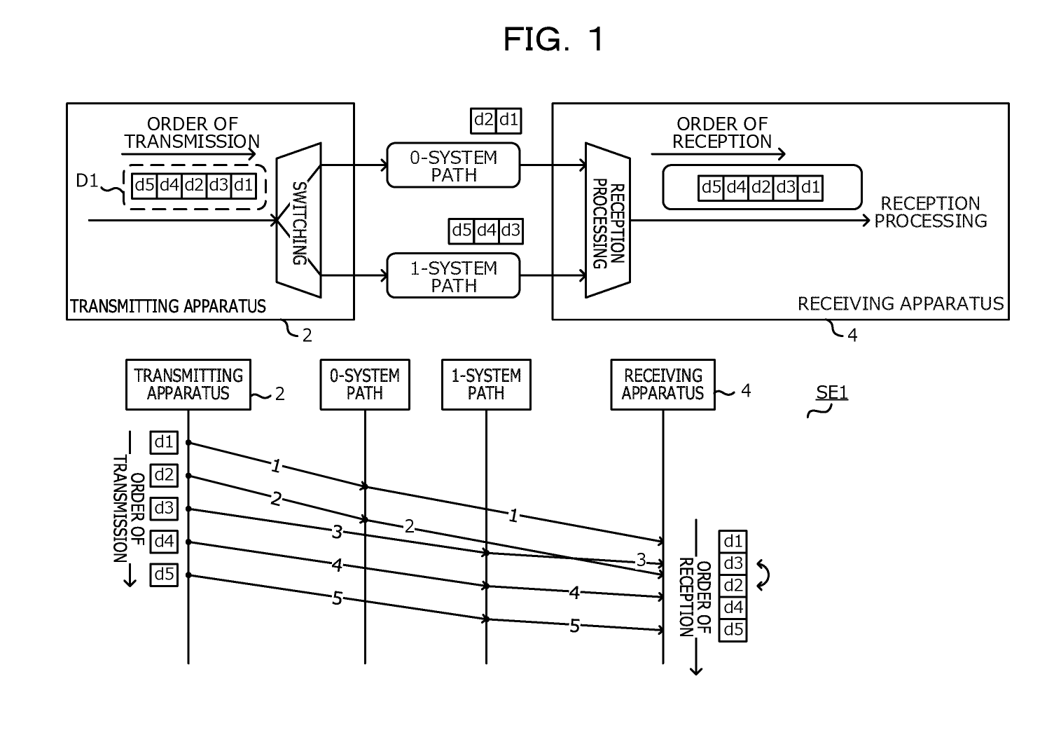

### DESCRIPTION OF EMBODIMENT

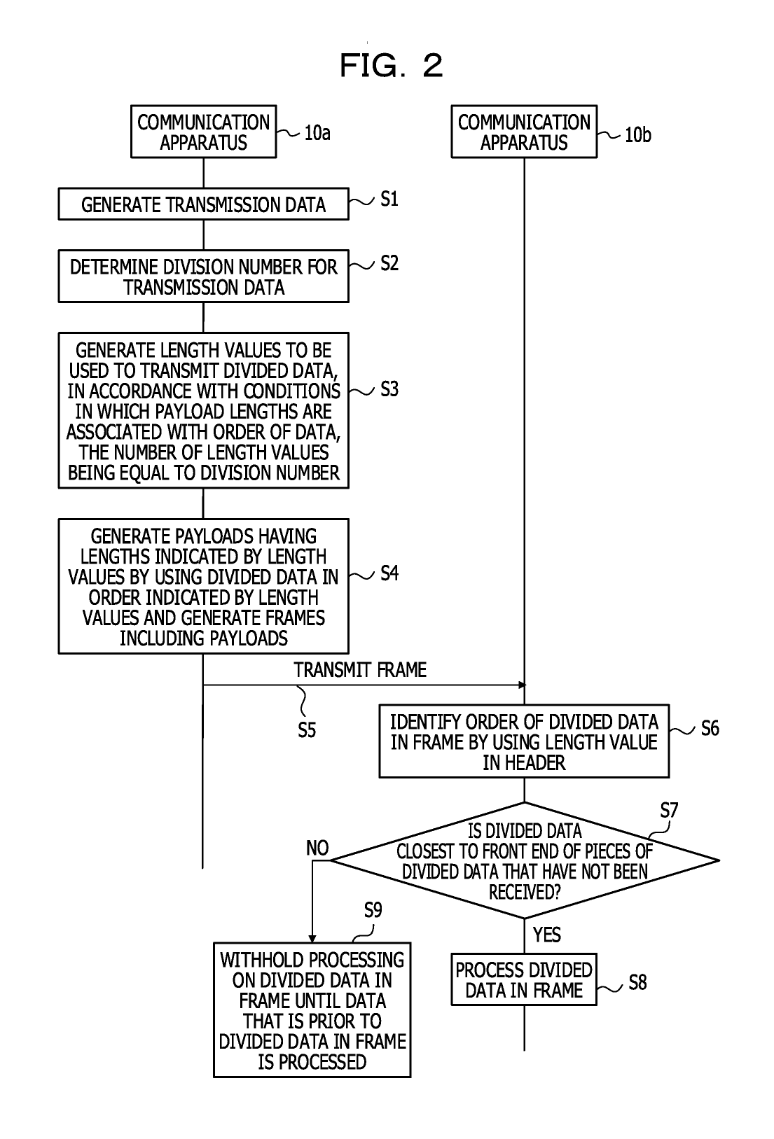

FIG. 2 is a sequence diagram illustrating an example of a communication method according to an embodiment. In FIG. 2, a description will be given of an example in which a communication apparatus 10a transmits data to a communication apparatus 10b. In a method according to the embodiment, each of the communication apparatuses 10a and 10b pre-stores conditions for associating information (length values) of payload lengths included in frames with an order of pieces of data in the respective frames. The length value indicating each payload length is included in a header of the frame.

The communication apparatus 10a generates transmission data for the communication apparatus 10b (S1). Next, the communication apparatus 10a determines a division number for the transmission data (S2). In accordance with the conditions in which the order of pieces of data is associated with payload lengths, the communication apparatus 10a generates length values to be applied to frames used to transmit pieces of divided data, the number of length values being equal to the division number (S3). The communication apparatus 10a divides the transmission data into a number of pieces of divided data which is equal to the division number. By using the pieces of divided data in an order indicated by the length values, the communication apparatus 10a generates payloads having lengths indicated by the length values, and generates frames including the payloads (S4). Thus, in the process in S4, each frame is generated so that the length value in the header indicates the order of the divided data.

In addition, the communication apparatus 10a transmits the generated frames to a destination address. A process in S5 and processes subsequent thereto will be described below with attention being paid to one of frames transmitted from the communication apparatus 10a to the communication apparatus 10b. The communication apparatus 10a transmits one of the generated frames to the communication apparatus 10b (S5). Upon receiving the frame, the communication apparatus 10b identifies the order of a piece of divided data in the frame by using the length value in the header (S6). The communication apparatus 10b determines whether or not the piece of divided data in the received frame is data that is the closest to the front end of the pieces of divided data that have not been received (S7). When the piece of divided data in the received frame is data that is the closest to the front end of the pieces of divided data that have not been received (Yes in S7), the communication apparatus 10b processes the piece of divided data in the received frame (S8). When the piece of divided data in the received frame is not data that is the closest to the front end of the pieces of divided data that have not been received (No in S7), the communication apparatus 10b withholds the processing on the divided data in the frame until it processes data that is prior to the divided data in the frame (S9).

A case in which the communication apparatus 10a transmits data and the communication apparatus 10b receives the data has been described with reference to FIG. 2 by way of example. However, each of the communication apparatuses 10 may perform both data transmission and reception.

As described above, by using the length value included in the header of a frame, the communication apparatus 10 according to the embodiment can identify the order of divided data included in the frame. Accordingly, it is possible to identify the order of divided data without reading a payload. In addition, the amount of load on the communication apparatus 10 during reception of a frame decreases, compared with the amount of load on an apparatus that performs reordering by using information in a payload.

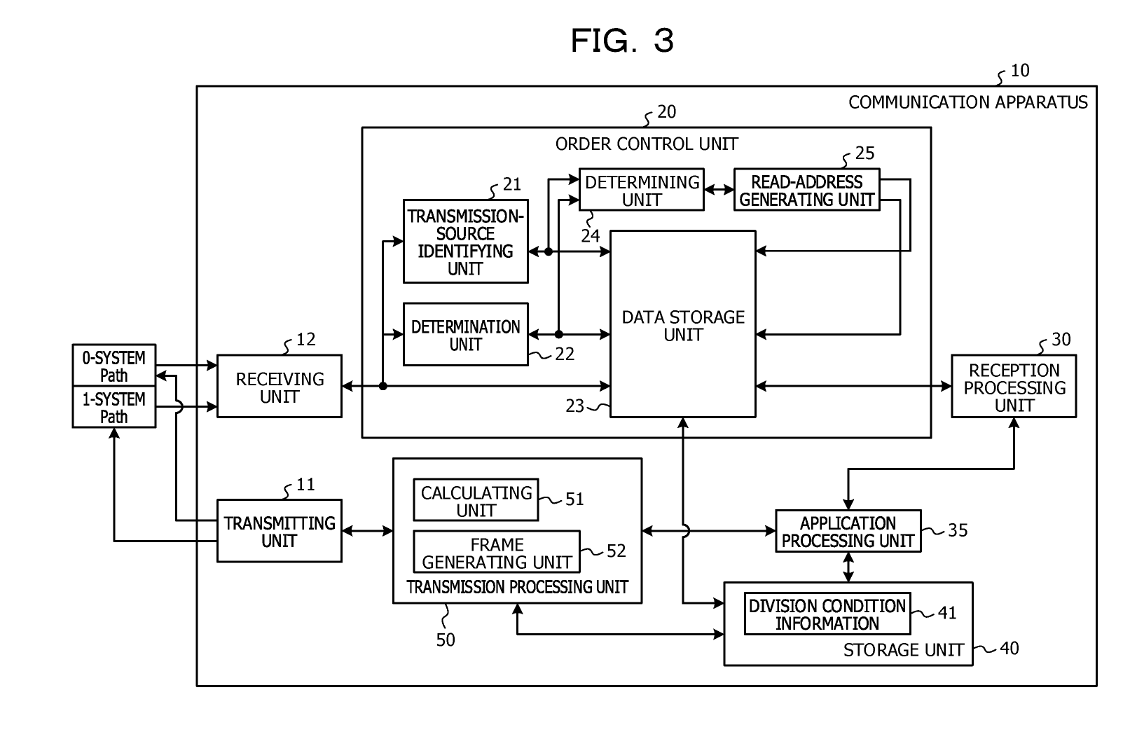

FIG. 3 is a diagram illustrating an example of the configuration of the communication apparatus 10. The communication apparatus 10 includes a transmitting unit 11, a receiving unit 12, an order control unit 20, a reception processing unit 30, an application processing unit 35, a storage unit 40, and a transmission processing unit 50. The order control unit 20 includes a transmission-source identifying unit 21, a determination unit 22, a data storage unit 23, a determining unit 24, and a read-address generating unit 25. The storage unit 40 holds division condition information 41. The transmission processing unit 50 includes a calculating unit 51 and a frame generating unit 52.

Each of the transmitting unit 11 and the receiving unit 12 may access both the 0-system path and the 1-system path. The transmitting unit 11 transmits frames to another apparatus. The receiving unit 12 receives frames from another apparatus. The receiving unit 12 outputs each of the received frames to the transmission-source identifying unit 21, the determination unit 22, and the data storage unit 23.

The transmission-source identifying unit 21 identifies a transmission source of the received frame. For example, the transmission-source identifying unit 21 may identify a media access control (MAC) address of the transmission source of the frame. When pieces of identification information have been allocated to respective communication apparatuses 10 in the system, the transmission-source identifying unit 21 may obtain the identification information associated with the communication apparatus 10 that is the transmission source of the frame. The determination unit 22 obtains the length value from the header of the frame, and determines the order of data in a payload by using the length value. In addition, in accordance with the order of data in the payload, the determination unit 22 selects a memory area in which the data in the payload is to be stored from areas allocated for storing data from the communication apparatus 10 that is the transmission source. The data storage unit 23 includes a memory used for data storage. The data storage unit 23 obtains information for identifying a frame transmission source from the transmission-source identifying unit 21. In addition, the data storage unit 23 obtains, from the determination unit 22, information about an area used for storing data in the frame. The data storage unit 23 stores the data in the frame in an area identified by a combination of the information obtained from the transmission-source identifying unit 21 and the information obtained from the determination unit 22.

With respect to a piece of divided data received using each frame, the determining unit 24 determines whether or not the piece of divided data is data that is the closest to the front end of unprocessed data. During the determination, the determining unit 24 uses the information obtained by the transmission-source identifying unit 21 and the information obtained by the determination unit 22, as appropriate. The determining unit 24 reports a result of the determination to the read-address generating unit 25. The read-address generating unit 25 generates, as the storage area of data to be read, an address allocated to the storage area of the data that is determined to be the closest to the front end of the unprocessed data. The data storage unit 23 outputs, to the reception processing unit 30, information about the address reported from the read-address generating unit 25. The reception processing unit 30 processes the input divided data in order, and outputs the data to the application processing unit 35, as appropriate. The application processing unit 35 performs data processing using application software.

Upon generating transmission data for the other communication apparatus 10, the application processing unit 35 outputs the transmission data to the calculating unit 51. By using the division condition information 41, the calculating unit 51 determines a division number for the data and payload lengths in frames including divided data. The division condition information 41 includes conditions for associating information about the payload lengths included in frames with the order of pieces of data in the frames. The frame generating unit 52 generates frames by using the division number and the length values determined by the calculating unit 51.

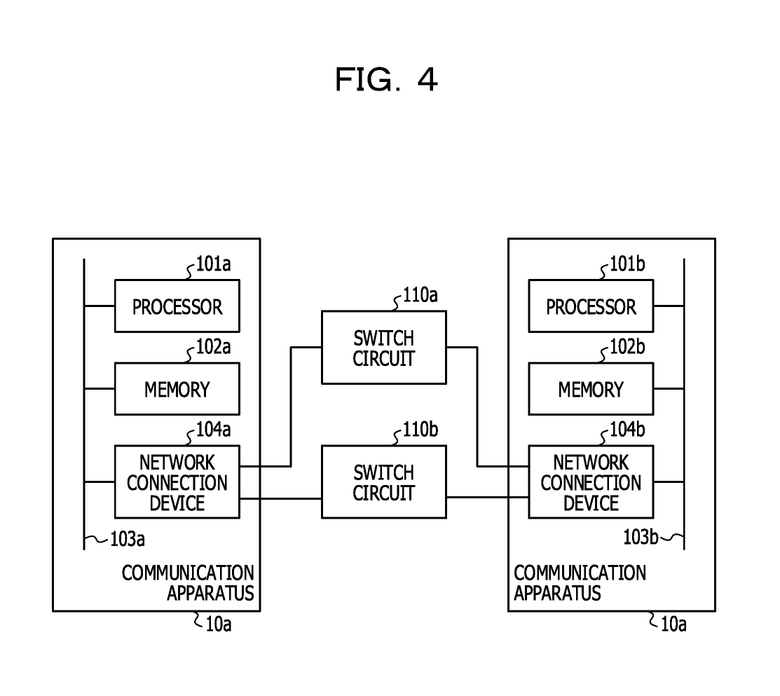

FIG. 4 is a diagram illustrating an example of the hardware configuration of apparatuses in a system. Communication apparatuses 10 (10a and 10b) include processors 101 (101a and 101b), memories 102 (102a and 102b), buses 103 (103a and 103b), and network connection devices 104 (104a and 104b), respectively. The 0-system path and the 1-system path are both implemented by switch circuits 110. For example, a 0-system path is realized by a switch circuit 110a, and a 1-system path is realized by a switch circuit 110b. Each processor 101 is an arbitrary processing circuit and is, for example, a central processing unit (CPU) or a large-scale integration (LSI) circuit. The processor 101 uses the corresponding memory 102 as a working memory and executes various types of processing by executing a program. Each memory 102 includes, for example, a random-access memory (RAM) and a nonvolatile memory, such as a read-only memory (ROM). The memory 102 is used to store a program and data used for processing performed by the processor 101. Each network connection device 104 is used to communicate with another apparatus through a network.

In addition, the communication apparatus 10 may optionally be capable of accessing a transportable storage medium. In such a case, the communication apparatus 10 may output data in the memory 102 to the transportable storage medium. The communication apparatus 10 may read a program, data, or the like from the transportable storage medium. In this case, the transportable storage medium is an arbitrary portable storage medium.

In each of the communication apparatuses 10, the transmission-source identifying unit 21, the determination unit 22, the determining unit 24, the read-address generating unit 25, the reception processing unit 30, the application processing unit 35, and the transmission processing unit 50 are implemented by the processor 101. The data storage unit 23 is implemented by the processor 101 and the memory 102. The storage unit 40 is implemented by the memory 102. The transmitting unit 11 and the receiving unit 12 are implemented by the network connection device 104 and the processor 101.

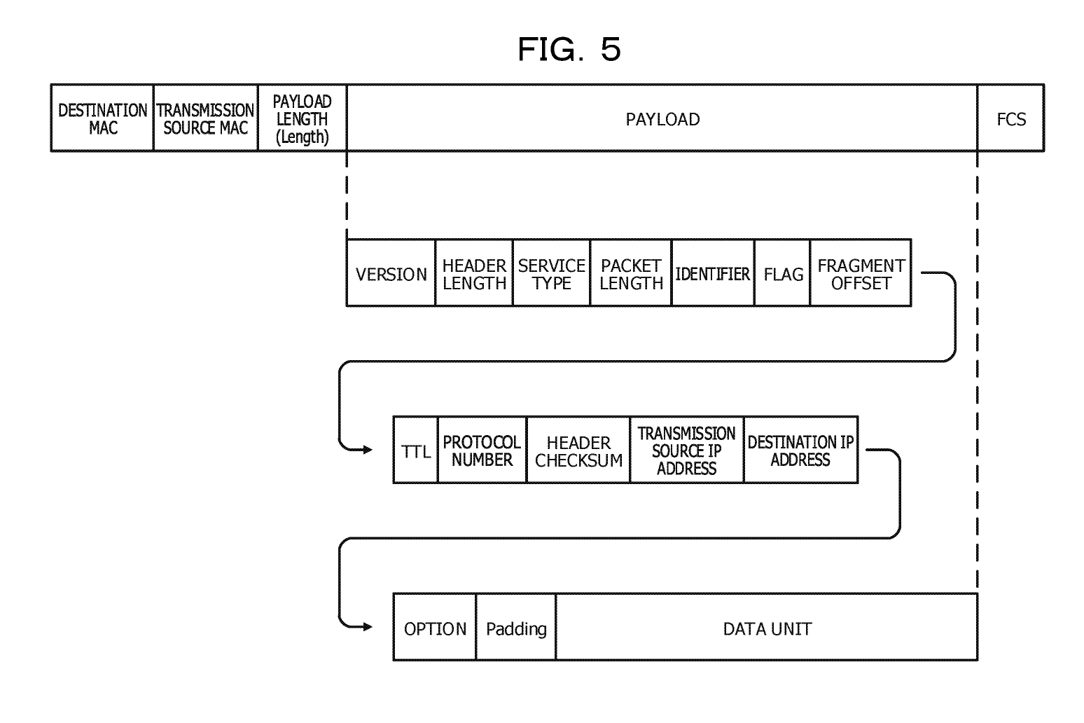

FIG. 5 is a diagram illustrating an example of the format of a frame. A frame used in a method according to the embodiment is an arbitrary frame having a header field in which the payload length of the frame is recorded. An example of a case in which an Ethernet frame is used is illustrated in FIG. 5. In the example illustrated in FIG. 5, the frame has a header, a payload, and a frame check sequence (FCS). The header includes a destination media access control (MAC) address, a transmission source MAC address, and a payload length (a length value). The FCS is used to check normality of the frame and is also used to store a cyclic redundancy check (CRC). The payload includes data transmitted from a transmission source and may also include other information. For instance, in the example illustrated in FIG. 5, the payload in the frame includes an internet protocol (IP) packet.

The IP packet includes an IP header in addition to the data. The IP header includes version information, a header length, a service type, a packet length, an identifier, a flag, a fragment offset, a time to live (TTL), a protocol number, a header checksum, a transmission source IP address, and a destination IP address. The IP header may further include an option field and padding for adjusting the length of the IP header. The IP header further includes a data field, which is used to store divided data generated by the communication apparatus 10 that performs transmission processing.

The following description in the embodiment will be separately given of frame generation in the communication apparatus 10 at a transmitting end and frame reception and analysis in the communication apparatus 10 at a receiving end. In the following description, it is assumed that each frame to be transmitted/received has the format described above with reference to FIG. 5.

(1) Generation of Frame to be Transmitted

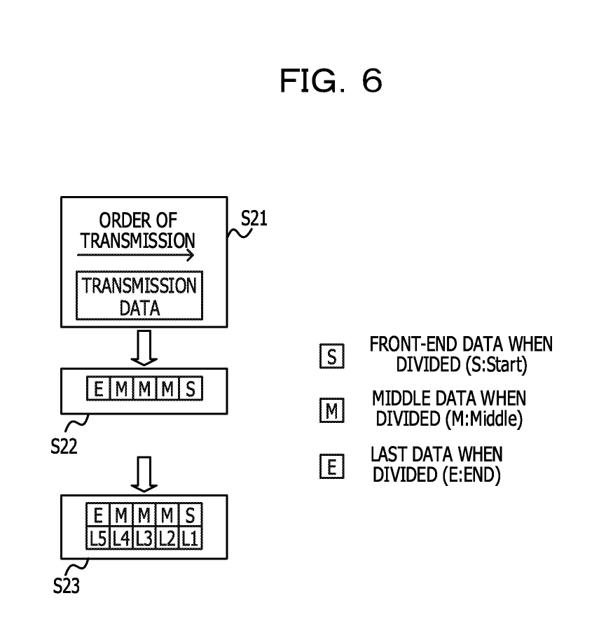

FIG. 6 is a diagram illustrating an example of data division processing. It is assumed that the application processing unit 35 generates transmission data, as denoted by S21. The application processing unit 35 outputs the transmission data to the calculating unit 51.

It is assumed that the calculating unit 51 pre-stores a reference value that serves as a reference for the size of divided data. When the transmission data is input, the calculating unit 51 determines the division number by using the size of the transmission data and the reference value. In this case, the reference value is a reference for a value that is expected to be effective for generating a number of pieces of divided data which allows the data to be equally transferred to both the 0-system path and the 1-system path. The reference value is calculated using, for example, the size of data transmitted/received in a communication system. In this case, by using the reference value, the calculating unit 51 sets the number of frames with which the total of the length of the transmission data and the lengths of IP headers corresponding to the division number can be transmitted as payloads. That is, when the division number is indicated by N, the total amount of data transmitted using payloads is determined by “transmission data”+“IP header length”×N. The calculating unit 51 determines the division number so that a value obtained by dividing the total amount of data by the division number is close to the reference value.

For example, it is assumed that the transmission data is 1100 bytes, the IP header length is 20 bytes, and the 256 bytes are stored as the reference value. The calculating unit 51 sets the value of N so that (“transmission data length”+“IP header length”×N)/N is close to the reference value. For example, the calculating unit 51 is assumed to set the division number N to 5. S22 indicates an example of a case in which the transmission data is divided into five pieces. In S22, the data (front-end data) at a front end of the pieces of divided data is represented by S, the divided data (last data) at the end of the pieces of divided data is represented by E (end), and each piece of divided data between the front-end data and the last data is represented by M (middle).

Next, by using the division condition information 41, the calculating unit 51 determines the length of a payload including each piece of data to be divided. It is assumed that the division condition information 41 is a combination of conditions 1 to 4 described below, by way of example.

Condition 1: when the length (length value) of a payload including divided data other than front-end data and the last data is represented in binary form, the bottom 4 bits are 0000.

Condition 2: when the length of a payload including the front-end data is represented in binary form, the value of the bottom fifth bit is 0, and the bottom 4 bits indicate the division number for data.

Condition 3: the length of a payload including middle data decreases, as the intermediate data gets closer to the front end, and increases in increments of 16 bits, as the intermediate data gets closer to the end.

Condition 4: when the length of a payload including the last data is represented in binary form, the value of the bottom fifth bit is 1, and the bottom four bits have values other than 0000.

For example, when the transmission data is divided into five pieces as illustrated in S23 in FIG. 6, the transmission data is 1100 bytes, and the IP header is 20 bytes, the total amount of data that is to be included in payloads is 1200 bytes=(1100+20×5). A payload length is hereinafter represented by a combination of alphabet “L” and a numeric value indicating the order of a piece of data included in the payload. For example, the length of a payload including the front-end data is denoted by L1, the length of a payload including the second divided data is denoted by L2, and the length of a payload including the third divided data is denoted by L3. In addition, the length of a payload including the fourth divided data is denoted by L4, and the length of a payload including the last data is denoted by L5. In this case, it is assumed that the calculating unit 51 determines L1 to L5 as follows:

L1: 165 bytes (0000 0000 1010 0101)

L2: 256 bytes (0000 0001 0000 0000)

L3: 272 bytes (0000 0001 0001 0000)

L4: 288 bytes (0000 0001 0010 0000)

L5: 219 bytes (0000 0000 1101 1011)

In this example, for ease of understanding, the binary representation of each payload length is indicated in parentheses, and the payload length in each frame is also indicated. The calculating unit 51 outputs the obtained payload lengths to the frame generating unit 52. The values of L1 to L5 are examples, and other values may also be determined for L1 to L5, as long as all of the conditions 1 to 4 are satisfied.

By using the payload lengths input from the calculating unit 51, the frame generating unit 52 generates frames to be transmitted. Each frame is hereinafter represented by a combination of alphabet “F” and a numeric value indicating the order of a piece of data included in the payload in the frame. For example, a frame including the front-end data is represented by F1.

The frame generating unit 52 sets the length of each piece of divided data to a length obtained by subtracting the IP header length from the payload length reported from the calculating unit 51. For example, since L1 is 165 bytes, the frame generating unit 52 designates the front-end 145 bytes in the transmission data as the front-end data and adds the IP header to the front-end data to generate an IP packet. In addition, the frame generating unit 52 generates a frame F1 in which the IP packet including the front-end data is included in the payload, and outputs the frame F1 to the transmitting unit 11. In addition, by performing similar processing, the frame generating unit 52 generates a frame F2 including the second divided data, a frame F3 including the third divided data, a frame F4 including the fourth divided data, and a frame F5 including the last data. The frame generating unit 52 also outputs the frames F2 to F5 to the transmitting unit 11.

The frame transmitting unit 11 transmits the frames input from the frame generating unit 52. In this case, the transmitting unit 11 uses both the 0-system path and the 1-system path so that the difference between the amount of transmission data through the 0-system path and the amount of transmission data through the 1-system path is minimized. For example, the transmitting unit 11 may alternately use the 0-system path and the 1-system path to transmit the frames F1 to F5. The transmitting unit 11 may alternately use the 0-system path the 1-system path for every two frames. In accordance with the frame lengths, the transmitting unit 11 may also select a path to be used for communication so that the difference between the amount of data transmitted through the 0-system path and the amount of data transmitted through the 1-system path is reduced.

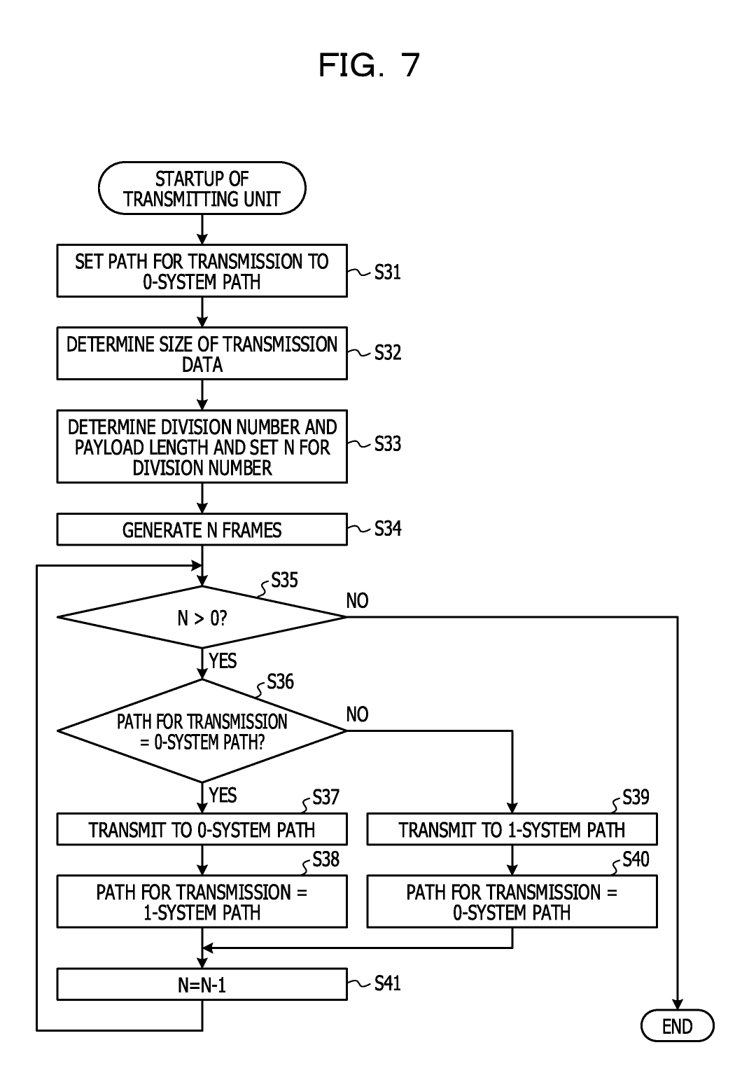

FIG. 7 is a flowchart illustrating an example of data transmission processing. FIG. 7 is an example, and the processing may be changed depending on an implementation. For example, a path that is used first for transmission by the transmitting unit 11 can be changed depending on an implementation. In FIG. 7, a variable N is used in order to count the number of frames to be processed.

The transmitting unit 11 sets the path used first for the transmission to the 0-system path (S11). The application processing unit 35 generates transmission data, and the calculating unit 51 determines the size of the transmission data (S32). The value determined in S32 indicates the total size of the transmission data.

In S33, the calculating unit 51 determines a division number and also determines the length of a payload in which each piece of divided data is to be included. The size of the divided data is determined according to the payload length and an IP header length. Thus, it can be said that the calculating unit 51 determines the length of each piece of divided data by determining the payload length. In addition, the calculating unit 51 sets the variable N for the division number.

The frame generating unit 52 generates frames by using the payload lengths determined by the calculating unit 51 and outputs the frames to the transmitting unit 11 (S34). The transmitting unit 11 determines whether or not the variable N is larger than 0 (S35). If the variable N is larger than 0 (Yes in S35), the transmitting unit 11 determines whether or not the path used for the transmission is the 0-system path (S36). If the path used for the transmission is the 0-system path (Yes in S36), the transmitting unit 11 transmits the frame to be processed to the 0-system path (S37) and changes the setting for the path used for the transmission to the 1-system path (S38). On the other hand, if the path used for the transmission is not the 0-system path (No in S36), the transmitting unit 11 transmits the frame to be processed to the 1-system path (S39) and changes the setting for the transmission destination to the 0-system path (S40). Subsequent to the process in S38 or S40, the transmitting unit 11 decrements the variable N by 1 and returns to S35 (S41). The processes in S35 to S41 are repeated until the variable N reaches 0. If the variable N reaches 0, the transmitting unit 11 ends the processing (No in S35).

(2) Reception and Analysis of Frame

The apparatus that has received the frame stores, in the data storage unit 23, the divided data in the received frame. In accordance with the order of data, the apparatus reads the divided data from the data storage unit 23 to adjust the order of data.

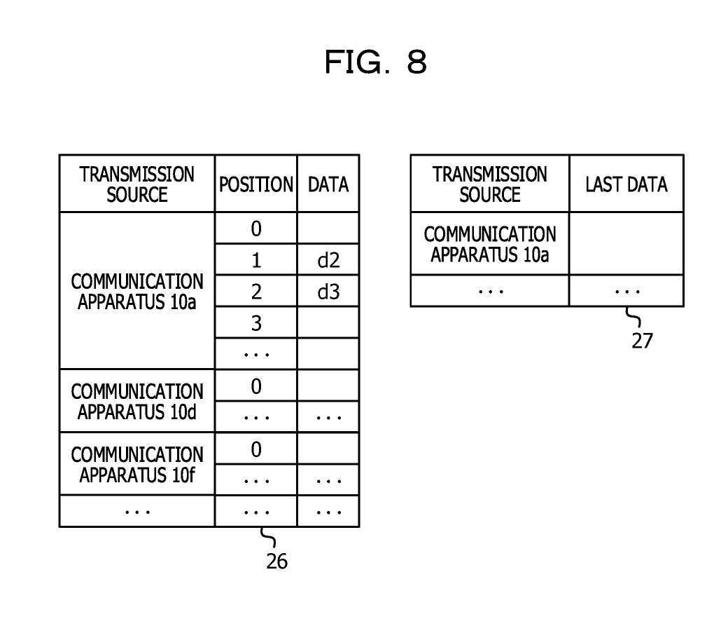

FIG. 8 illustrates an example of storage regions of divided data. The data storage unit 23 includes a data storage region 26 and a last-data storage region 27. The data storage region 26 is a region used to store the divided data other than the last data. The data storage region 26 has, for each communication apparatus 10 that is the transmission source of a frame, an area for storing divided data received from the communication apparatus 10. The area associated with each transmission source has a plurality of data storage areas. A numerical value indicating the position of each storage area is associated with the storage area. In this case, the area for storing the divided data is determined according to the transmission source of a received frame including the divided data and the order of the divided data. For each communication apparatus 10 of the transmission source of frames, the last data received from the communication apparatus 10 is stored in the last-data storage region 27.

In the communication apparatus 10 that has received a frame, the transmission-source identifying unit 21 identifies the transmission source by using, for example, information about the MAC address of the frame. The determination unit 22 then identifies the order of divided data in the frame. Details of processing performed by the determination unit 22 are described later. Accordingly, the storage area for the data in the received frame is determined using processing results of the transmission-source identifying unit 21 and the determination unit 22.

FIG. 8 illustrates an example of the data storage unit 23 included in the communication apparatus 10b when the communication apparatus 10b receives frames from the communication apparatus 10a, a communication apparatus 10d, a communication apparatus 10f, and so on. FIG. 8 also illustrates the zeroth to fourth areas of storage areas for divided data included in the frames whose transmission source is the communication apparatus 10a. The number of storage areas associated with one transmission source is set to a number that is larger than or equal to the maximum value of the division number that can be used for dividing one piece of data in the system. In the example illustrated in FIG. 8, second divided data d2 and third divided data d3 are stored. However, a frame including divided data d1 at the front end has not arrived at the communication apparatus 10b and is thus not stored in the data storage region 26. In addition, upon receiving a frame including the last divided data from the communication apparatus 10a, the communication apparatus 10b stores the last divided data in an area included in the last-data storage region 27 and associated with the communication apparatus 10a.

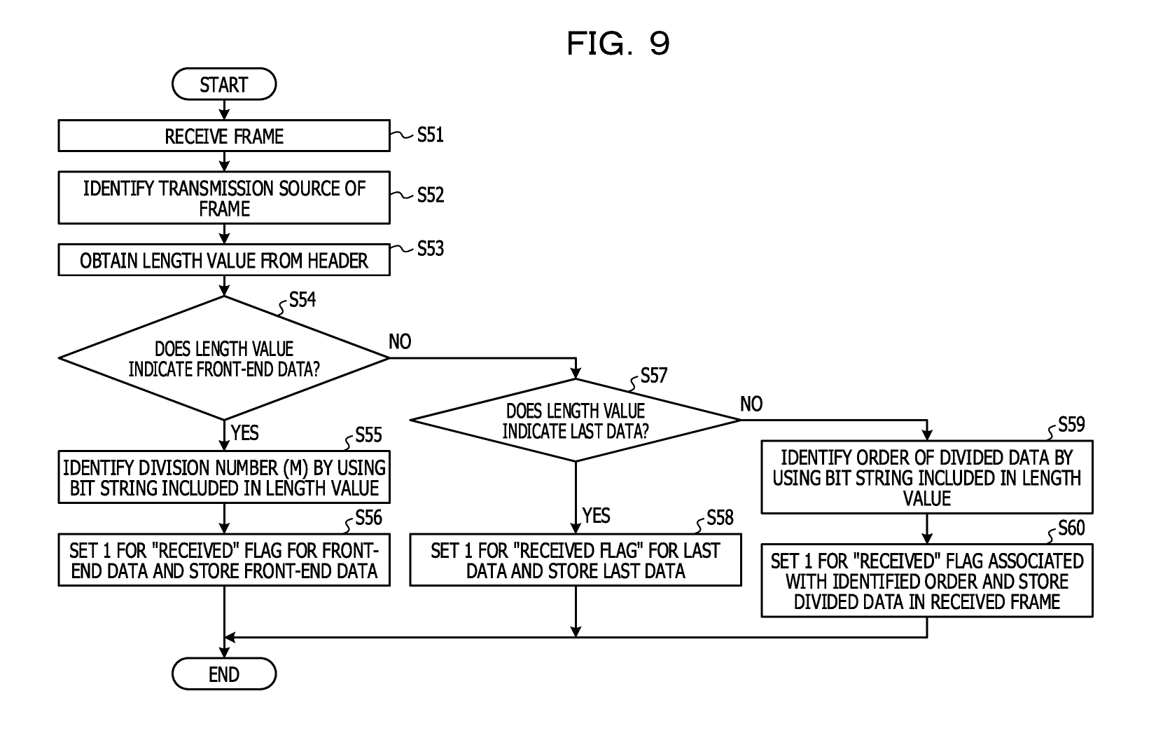

FIG. 9 is a flowchart illustrating an example of divided-data storage processing performed by the communication apparatus 10 that receives a frame. In the example illustrated in FIG. 9, the determining unit 24 is assumed to use a “received” flag for divided data. The “received” flag=1 indicates that divided data associated with the flag is already stored in the data storage unit 23. The “received” flag=0 indicates that the divided data associated with the flag is already read from the data storage unit 23.

The receiving unit 12 in the communication apparatus 10 receives a frame (S51). The transmission-source identifying unit 21 identifies the transmission source of the frame (S52). The determination unit 22 obtains a length value from the header of the frame (S53) and uses the division condition information 41 to determine whether or not the length value indicates front-end data (S54). If the length value indicates front-end data (Yes in S54), the determination unit 22 determines that data in the received frame is front-end data. In addition, by using a bit string included in the length value, the determination unit 22 identifies a division number (M) (S55). The determining unit 24 sets 1 for a “received” flag for the front-end data associated with the transmission source of the frame. The data storage unit 23 stores the front-end data in the received frame in a front-end data storage area associated with the transmission source of the frame (S56).

If the length value is not a value indicating front-end data (No in S54), the determination unit 22 uses the division condition information 41 to determine whether or not the length value indicates last data (S57). If the length value is a value indicating last data (Yes in S57), the determination unit 22 determines that the data in the received frame is last data. Subsequently, the determining unit 24 sets 1 for a “received” flag for the last data associated with the transmission source of the frame. The data storage unit 23 then stores the last data in a storage area included in the last-data storage region 27 and associated with the transmission source of the frame (S58).

If the length value is not a value indicating last data, the determination unit 22 identifies the order of the divided data by using the division condition information 41 and a bit string included in the length value (S59). The determining unit 24 sets 1 for a “received” flag for the divided data associated with the transmission source of the frame and the identified order. The data storage unit 23 then stores the divided data in the received frame in a storage area associated with the transmission source of the frame and the identified order (S60).

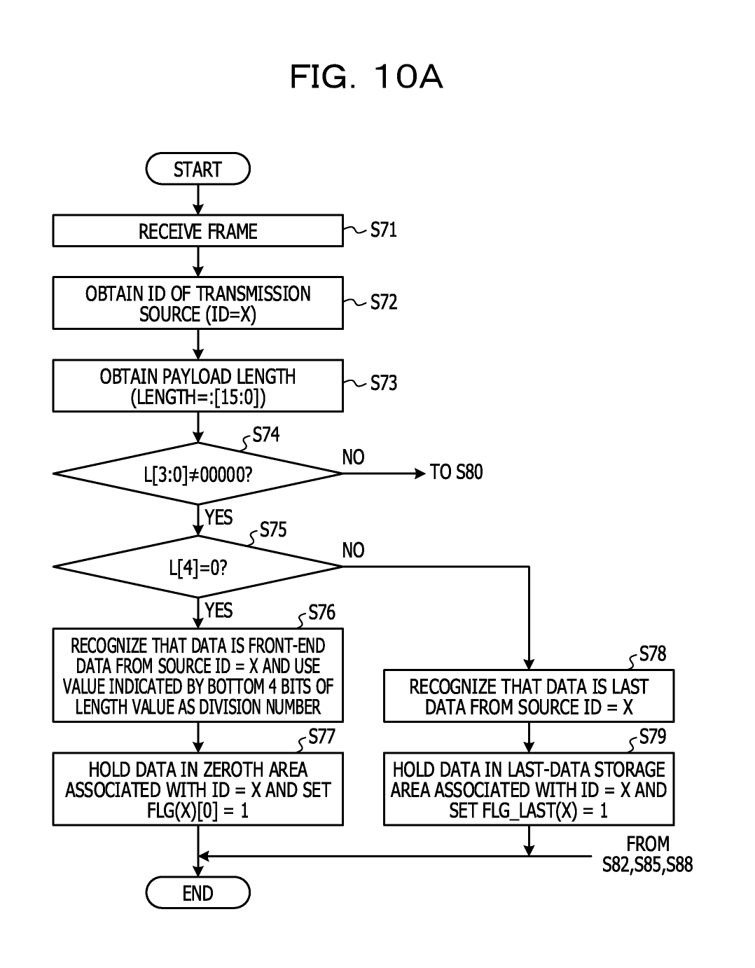

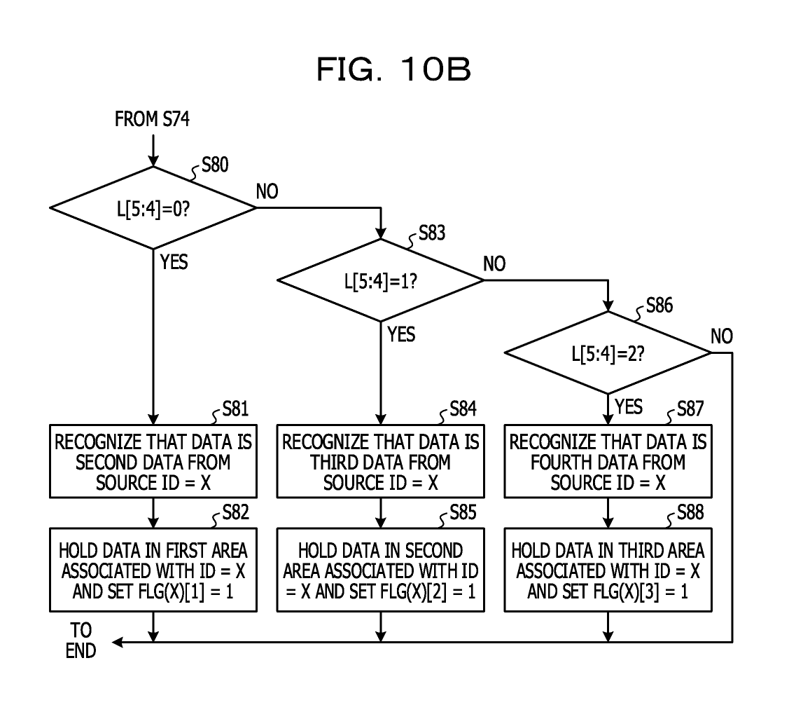

FIGS. 10A and 10B are flowcharts illustrating an example of the divided-data storage processing. With reference to FIGS. 10A and 10B, an example of processing performed by the communication apparatus 10b, including a specific example of determination processing performed by the determination unit 22 in the communication apparatus 10b that receives a frame from the communication apparatus 10a, will be described in conjunction with an example of a case in which the communication apparatus 10b holds division condition information 41 that is the same as that in the communication apparatus 10a. In the description in FIGS. 10A and 10B, the payload length of a frame transmitted from the communication apparatus 10a is assumed to be the same as that described above with reference to FIG. 6.

In the following description, in order to clarify the communication apparatus 10 that is performing operation, the end of each reference numeral may be accompanied by an alphabet allocated to the communication apparatus 10 that is performing the operation. For example, a transmitting unit 11a corresponds to the transmitting unit 11 in the communication apparatus 10a, and a receiving unit 12b corresponds to the receiving unit 12 in the communication apparatus 10b. In addition, in FIGS. 10A and 10B, identification information (ID) has been allocated to each communication apparatus 10 included in the communication system. The transmission-source identifying unit 21 in each communication apparatus 10 identifies a transmission source by using the ID.

In the example illustrated in FIGS. 10A and 10B, “received” flags for data other than last data and a “received” flag for the last data are independently managed in order to simplify management of data regardless of the division number. FLG(X)[n] is a flag indicating whether or not the nth divided data transmitted from the communication apparatus 10 to which ID=X is allocated is received. FLG_LAST(X) is a flag indicating whether or not last data transmitted from the communication apparatus 10 to which ID=X is allocated is received. Also, 1 is set for each of FLG(X)[n] and FLG_LAST(X), upon reception of data associated with the flag. Each of the “received” flags for data other than the last data and the “received” flag for the last data is initialized when the communication apparatus 10 is started up.

The receiving unit 12b in the communication apparatus 10b receives a frame (S71). Upon receiving the frame, the receiving unit 12b in the communication apparatus 10b outputs the received frame to a transmission-source identifying unit 21b, a determination unit 22b, and a data storage unit 23b. By using a transmission-source ID (source ID) included in the received frame, the transmission-source identifying unit 21b identifies that the transmission source of the frame is the communication apparatus 10a (S72). It is assumed that ID=X has been allocated to the communication apparatus 10a, by way of example. The transmission-source identifying unit 21b outputs an obtained result to the data storage unit 23b.

The determination unit 22b obtains the payload length in the received frame from the length value in the Ethernet header (S73). A notation “L[n]” is used to indicate bits to be processed in the length value. In the notation L[n], n indicates the range of bits to be processed. When the number of bits to be processed is 1 bit, n indicates the number of bits from the least significant bit to the bit to be processed in a bit string. For example, L[0] indicates the value of the least significant bit of the length value. When the number of bits to be processed is 2 bits or more, a value in which the starting position and the ending position in a bit string to be processed is sectioned by a colon is used as n. Each of the starting position and the ending position in a bit string to be processed is represented by the number of bits from the least significant bit bit. For example, when the entire 16 bits of the length value are represented, the starting position and the ending position in a bit string to be processed are represented by L[15:0].

The determination unit 22b determines whether or not the bottom 4 bits (L[3:0]) in a bit string indicating the length value in the received frame are 0000 (S74). If the bottom 4 bits of the length value in the received frame are not 0000 (Yes in S74), the divided data is either the front-end data or the last data according to conditions 2 and 4 in the division condition information 41. Accordingly, the determination unit 22b determines whether or not the value of the fifth bit (L[4]) from the bottom of the length value in the received frame is 0 (S75).

If the value of the fifth bit (L[4]) from the bottom of the length value in the received frame is 0 (Yes in S75), the determination unit 22b determines that the frame to be processed is the front-end data, based on condition 2 in the division condition information 41. The determination unit 22b outputs an obtained determination result to the data storage unit 23b. Thus, based on processing results of the transmission-source identifying unit 21b and the determination unit 22b, the data storage unit 23b recognizes that the data in the received frame is front-end data from Source ID=X (the communication apparatus 10a). In addition, based on condition 2 in the division condition information 41, the bottom 4 bits in the payload length in the frame including the front-end data have been set to a division number. Thus, the determination unit 22b use the value indicated by the bottom 4 bits (L[3:0]) of the length value as the division number (S76). The data storage unit 23b holds the data in the received frame in a zeroth area associated with ID=X. In the case, the processing results of the transmission-source identifying unit 21b and the determination unit 22b are also output to a determining unit 24b. Thus, the determining unit 24b sets 1 for a flag (FLG(X)[0]) indicating the reception status of the front-end data from Source ID=X (the communication apparatus 10a) (S77).

If the value of the fifth bit (L[4]) from the bottom of the length value in the received frame is 1 (No in S75), the determination unit 22b determines that the frame to be processed is the last data, based on condition 4 in the division condition information 41. Based on the processing results of the transmission-source identifying unit 21b and the determination unit 22b, the data storage unit 23b recognizes that the data in the received frame is the last data transmitted from Source ID=X (the communication apparatus 10a) (S78). The data storage unit 23b holds the data in the received frame in an area included in the last-data storage region 27 and associated with the communication apparatus 10a (ID=X). The determining unit 24b also sets 1 for a flag (FLG_LAST(X)[0]) indicating the reception status of the last data from Source ID=X (the communication apparatus 10a) (S79).

If the bottom 4 bits of the length value in the received frame are 0000, the divided data is neither the front-end data nor the last data according to condition 1 in the division condition information 41 (No in S74). Thus, by using the obtained length value and the division condition information 41, the determination unit 22b determines the order of the data included in the received frame. For example, based on condition 3 in the division condition information 41, the determination unit 22b identifies the order of pieces of data in frames in order of increasing payload lengths. The payload increases in increments of 16 bits, as the middle data gets closer to the end of data, and thus the determination unit 22b performs comparison between pieces of middle data by using the values of bit strings higher than the bottom 5 bits thereof. For example, when data is divided into five pieces of data, the number of pieces of middle divided data is three. According to condition 3 in the division condition information 41, the length of a payload including middle divided data increases in increments of 16 bits, as the middle divided data gets closer to the end of the data. Accordingly, in accordance with a value indicated by a bit string (L[5:6]) of the bottom fifth and sixth bits of the length value, the determination unit 22b determines the order of divided data included in the payload.

If the value of the bit string (L[5:6]) of the bottom fifth and sixth bits of the length value is 0 (Yes in S80), the determination unit 22b determines that the received frame includes data (second divided data) that is the closest to the front-end data of pieces of middle divided data. Based on the processing results of the transmission-source identifying unit 21b and the determination unit 22b, the data storage unit 23b recognizes that the data in the received frame is the second divided data from Source ID=X (the communication apparatus 10a) (S81). The data storage unit 23b holds the data in the received frame in a first area associated with ID=X. The determining unit 24b sets 1 for a flag (FLG(X)[1]) indicating the reception status of the second divided data from Source ID=X (the communication apparatus 10a) (S82).

If the value of the bit string (L[5:6]) of the bottom fifth and sixth bits of the length value is not 0 (No in S80), the determination unit 22b determines whether or not the value of the bit string of the bottom fifth and sixth bits of the length value is 1 (S83). If the value of the bit string of the bottom fifth and sixth bits of the length value is 1 (Yes in S83), the determination unit 22b determines that the received frame includes data (third divided data) that is the second closest to the front-end of the pieces of middle divided data. Based on the processing results of the transmission-source identifying unit 21b and the determination unit 22b, the data storage unit 23b recognizes that the data in the received frame is the third divided data from Source ID=X (the communication apparatus 10a) (S84). The data storage unit 23b holds the data in the received frame in a second area associated with ID=X. The determining unit 24b also sets 1 for a flag (FLG(X)[2]) indicating the reception status of the third divided data from Source ID=X (the communication apparatus 10a) (S85).

If the value of the bit string (L[5:6]) of the bottom fifth and sixth bits of the length value is not 1 (No in S83), the determination unit 22b determines whether or not the value of the bit string of the bottom fifth and sixth bits of the length value is 2 (S86). If the value of the bit string of the bottom fifth and sixth bits of the length value is 2 (Yes in S86), the determination unit 22b determines whether or not the received frame includes data (fourth divided data) that is the third closest to the front-end of the pieces of middle divided data. Based on the processing results of the transmission-source identifying unit 21b and the determination unit 22b, the data storage unit 23b recognizes that the data in the received frame is the fourth divided data from Source ID=X (the communication apparatus 10a) (S87). The data storage unit 23b holds the data in the received frame in a third area associated with ID=X. The determining unit 24b also sets 1 for a flag (FLG(X)[3]) indicating the reception status of the fourth divided data from Source ID=X (the communication apparatus 10a) (S88).

The processes in FIGS. 10A and 10B are examples, and the order of the processes may be changed depending on an implementation. For example, the determination in S83 and/or the determination in S86 may be performed before the determination in S80. The description in FIG. 10 has been given of an example of a case in which the fifth and sixth bits from the bottom of the length value are used to determine the order of middle divided data. However, an arbitrary number of bits may be used to identify the order of middle divided data.

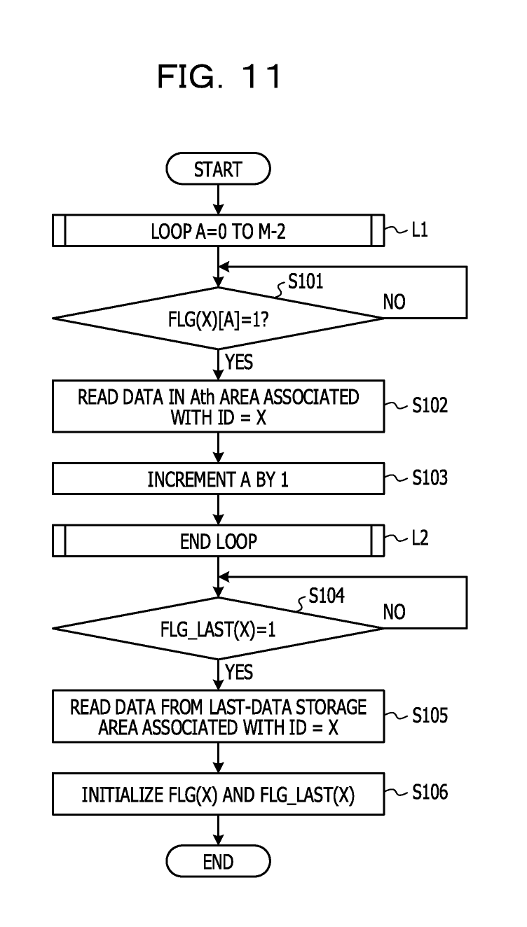

FIG. 11 is a flowchart illustrating an example of divided-data reading processing. In FIG. 11, a variable A and a constant M are used. The variable A is a number indicating the position of an area in which divided data to be read is stored. The constant M is a division number for data. At the time of starting the processing in FIG. 11, the value of the variable A is initialized to 0. The following description will also be given of an example of a case in which the communication apparatus 10a transmits a frame to the communication apparatus 10b. It is also assumed that an ID “X” has been allocated to the communication apparatus 10a.

Processes in S101 to S103 between loop ends L1 and L2 are repeated, as long as a condition stated at loop end L1 is satisfied. The determining unit 24b determines whether or not 1 has been set for a flag (FLG(X)[A]) indicating the reception status of the Ath divided data transmitted from the communication apparatus 10 to which ID=X is allocated (S101). When 1 has not been set for FLG(X)[A] (No in S101), the determining unit 24b stands by. When FLG(X)[A] is 1 (Yes in S101), a read-address generating unit 25b designates the Ath area associated with ID=X as a read address and reports the Ath area to the data storage unit 23b. With this process, the read-address generating unit 25b causes the data storage unit 23b to read data stored at the designated address (S102). Thereafter, the determining unit 24b increments the variable A by 1 (S103).

If the variable A reaches M−2, the determining unit 24b finishes the processes between loop ends L1 and L2. The determining unit 24b determines whether or not 1 has been set for a flag (FLG_LAST(X)) indicating the reception status of the last data transmitted from the communication apparatus 10 to which ID=X is allocated (S104). If 1 has not been set for FLG_LAST(X) (No in S104), the determining unit 24b stands by. If FLG_LAST(X) is 1 (Yes in S104), the read-address generating unit 25b generates an address of an area included in the last-data storage region 27 and associated with ID=X and reports the address to the data storage unit 23b. With this process, the read-address generating unit 25b causes the data storage unit 23b to read data stored at the generated address (S105). Subsequent to the process in S105, the determining unit 24b initializes FLG(X) and FLG_LAST(X) used to determine the reception state of data received from the communication apparatus 10 (the communication apparatus 10a) to which ID=X is allocated (S106).

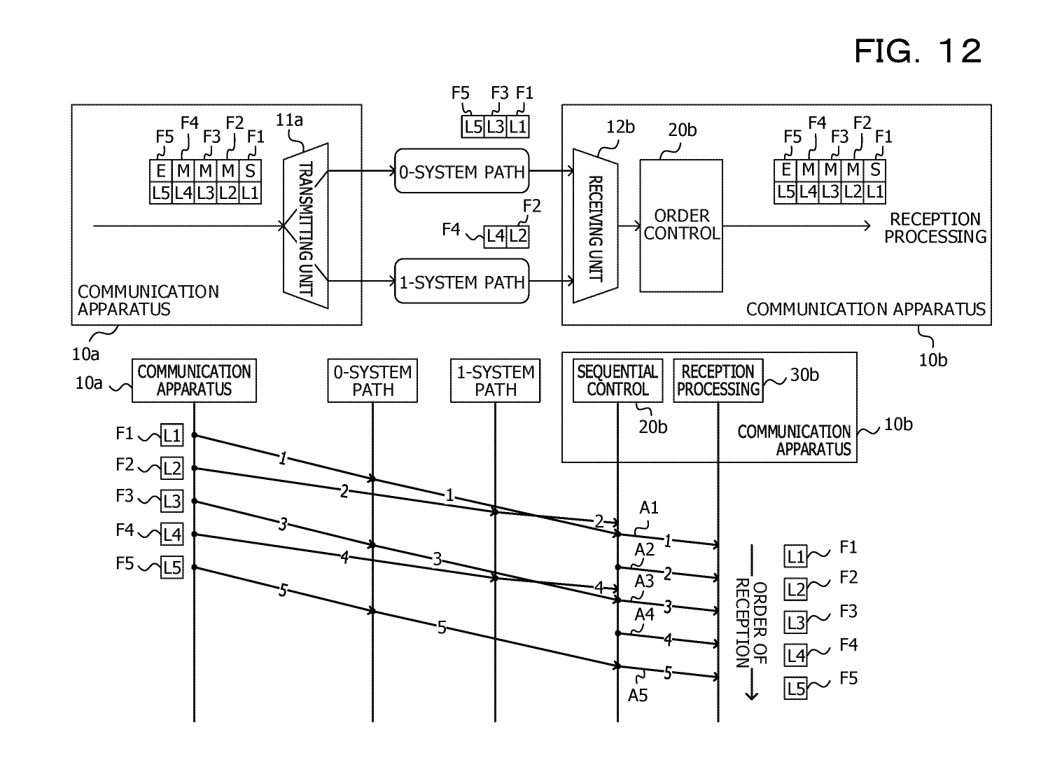

FIG. 12 is a sequence diagram illustrating an example of communication processing. In which order the data is output to a reception processing unit 30b when the communication apparatus 10b performs the processing, described above using FIGS. 10 and 11, on a frame received from the communication apparatus 10a will be described in chronological order with reference to FIG. 12. In the example illustrated in FIG. 12, frames F1 to F5 are transmitted from the communication apparatus 10a in the order F1, F2, F3, F4, and F5. The transmitting unit 11a transmits the frames F1, F3, and F5 through the 0-system path and transmits the frames F2 and F4 through the 1-system path. In this case, the amount of time taken for each frame transmitted from the communication apparatus 10a through the 0-system path to arrive at the communication apparatus 10b is larger than the amount of time taken for each frame transmitted from the communication apparatus 10a through the 1-system path to arrive at the communication apparatus 10b. Thus, the frames F1 to F5 arrive at the receiving unit 12b in the communication apparatus 10b in the order F2, F1, F4, F3, and F5.

In addition, it is assumed that the frames F1 to F5 have the following payload lengths.

L1: 165 bytes (0000 0000 1010 0101)

L2: 256 bytes (0000 0001 0000 0000)

L3: 272 bytes (0000 0001 0001 0000)

L4: 288 bytes (0000 0001 0010 0000)

L5: 219 bytes (0000 0000 1101 1011)

In the example illustrated in FIG. 12, the maximum value of the division number is pre-set to 16. In this case, the order of middle divided data is identified by a numerical value indicated by a bit string of the fifth to eighth bits of the length value indicating the payload length.

Upon receiving the frame F2, the receiving unit 12b in the communication apparatus 10b outputs the frame F2 to the transmission-source identifying unit 21b, the determination unit 22b, and the data storage unit 23b. The transmission-source identifying unit 21b identifies that the transmission source is the communication apparatus 10a. Since the payload length L2 of the frame F2 is represented as 0000 0001 0000 0000 in binary form, and the bottom 4 bits are 0000, the determination unit 22b determines that the received frame includes middle divided data. In addition, since the value of the bottom fifth to eighth bits of the payload length L2 is 0, the determination unit 22b determines that the frame F2 includes the second divided data, based on condition 3 in the division condition information 41. The data in the frame F2 is stored in a first area in the data storage region 26 included in the data storage unit 23b. The determining unit 24b sets 1 for FLG(X)[1] indicating the reception status of the second divided data.

Upon receiving the frame F1, the receiving unit 12b outputs the frame F1 to the transmission-source identifying unit 21b, the determination unit 22b, and the data storage unit 23b. Upon obtaining the payload length L1 (0000 0000 1010 0101) of the frame F1, the determination unit 22b determines that the frame F1 includes the front-end data, since the bottom 4 bits are not 0000, and the bottom fifth bit is 0. In addition, since the values of the bottom 4 bits of the payload length L1 are 0101, the determination unit 22b determines that the division number is 5. The data in the frame F1 is stored in a zeroth area in the data storage region 26 included in the data storage unit 23b. The determining unit 24b sets 1 for FLG(X)[0] indicating the reception status of the front-end data. Since 1 has been set for FLG(X)[0], the read-address generating unit 25b sets the read address to the address of the zeroth area in the data storage region 26, and thus the data storage unit 23b outputs the front-end data to the reception processing unit 30b (arrow A1).

When the reading of the front-end data finishes, the determining unit 24b determines whether or not 1 has been set for a flag FLG(X)[1] indicating the reception status of the second divided data. At this point in time, since 1 has been set for FLG(X)[1], the read-address generating unit 25b sets the read address to the address of the first area in the data storage region 26. Subsequently, the data storage unit 23b reads the second divided data from the designated area and outputs the second divided data to the reception processing unit 30b (arrow A2).

The receiving unit 12b receives the frame F4. Upon obtaining the payload length L4 (0000 0001 0010 0000) of the frame F4, the determination unit 22b determines that the received frame includes middle divided data, since the bottom 4 bits are 0000. In addition, since the value of the fifth to eighth bits of the payload length L4 is 2, the determination unit 22b determines that the frame F4 includes the fourth divided data. The data in the frame F4 is stored in a third area in the data storage region 26 included in the data storage unit 23b. The determining unit 24b sets 1 for FLG(X)[3] indicating the reception status of the fourth divided data.

The receiving unit 12b receives the frame F3. Upon obtaining the payload length L3 (0000 0001 0001 0000) of the frame F3, the determination unit 22b determines that the received frame includes middle divided data, since the bottom 4 bits are 0000. In addition, since the value of the bottom fifth to eighth bits of the payload length L4 is 1, the determination unit 22b determines that the frame F3 includes the third divided data. The data in the frame F3 is stored in a second area in the data storage region 26 included in the data storage unit 23b. The determining unit 24b sets 1 for FLG(X)[2] indicating the reception status of the third divided data. Since 1 has been set for FLG(X)[2], the read-address generating unit 25b sets the read address to the address of the second area in the data storage region 26. The read-address generating unit 25b then reports the read address to the data storage unit 23b. Thus, the data storage unit 23b outputs the third divided data to the reception processing unit 30b (arrow A3).

When the reading of the third divided data is finished, the determining unit 24b determines whether or not 1 has been set for the flag FLG(X)[3] indicating the reception status of the fourth divided data. At this point in time, 1 has been set for FLG(X)[3]. Accordingly, the read-address generating unit 25b sets the read address to the address of the third area in the data storage region 26. Subsequently, the data storage unit 23b reads the fourth divided data from the designated area and outputs the fourth divided data to the reception processing unit 30b (arrow A4).

In this case, the division number M is 5, and the reading from the areas in a data storage region 26b has been finished up to the third area, which is indicated by M−2. Thus, the determining unit 24b determines that the data other than the last data have been output to the reception processing unit 30b and starts monitoring the reception status of the last data. During the monitoring, the value of FLG_LAST(X) is monitored.

The receiving unit 12b receives the frame F5. Upon obtaining the payload length L5 (0000 0000 1101 1011) of the frame F5, the determination unit 22b determines that the received frame includes the last data, since the bottom 4 bits are not 0000, and the bottom fifth bit is 1. The data in the frame F5 is stored in an area included in the last-data storage region 27 in the data storage unit 23b and associated with the communication apparatus 10a. The determining unit 24b sets 1 for FLG_LAST(X) indicating the reception status of the last data. Since 1 has been set for FLG_LAST(X), the read-address generating unit 25b sets the area included in the last-data storage region 27 and associated with the communication apparatus 10a to the address of the area to be read. Thus, the data storage unit 23b outputs the last data to the reception processing unit 30b (arrow A5).

As described above with reference to FIG. 12, even when the communication apparatus 10b does not receive the frames F1 to F5 according to the order of pieces of data in the frames, the communication apparatus 10b is capable of processing the frames in parallel with receiving the frames, while correcting the order of the pieces of data. With the method according to the embodiment, during reception of frames, the order of pieces of data is controllable using the information of the payload lengths in the respective headers, and thus the amount of load on the communication apparatus 10 at the receiving end decreases, compared with a case in which the order of pieces of data is controlled using information in the payloads. In addition, the communication apparatus 10b processes the received divided data when it is the front-end data of pieces of unprocessed data, as denoted by arrows A1 to A5 in FIG. 12. Thus, the communication apparatus 10 according to the embodiment can process the data in each frame, before completing reception of all frames including divided data. Accordingly, since the reception processing at the receiving end is started at an early stage, the processing is performed efficiently.

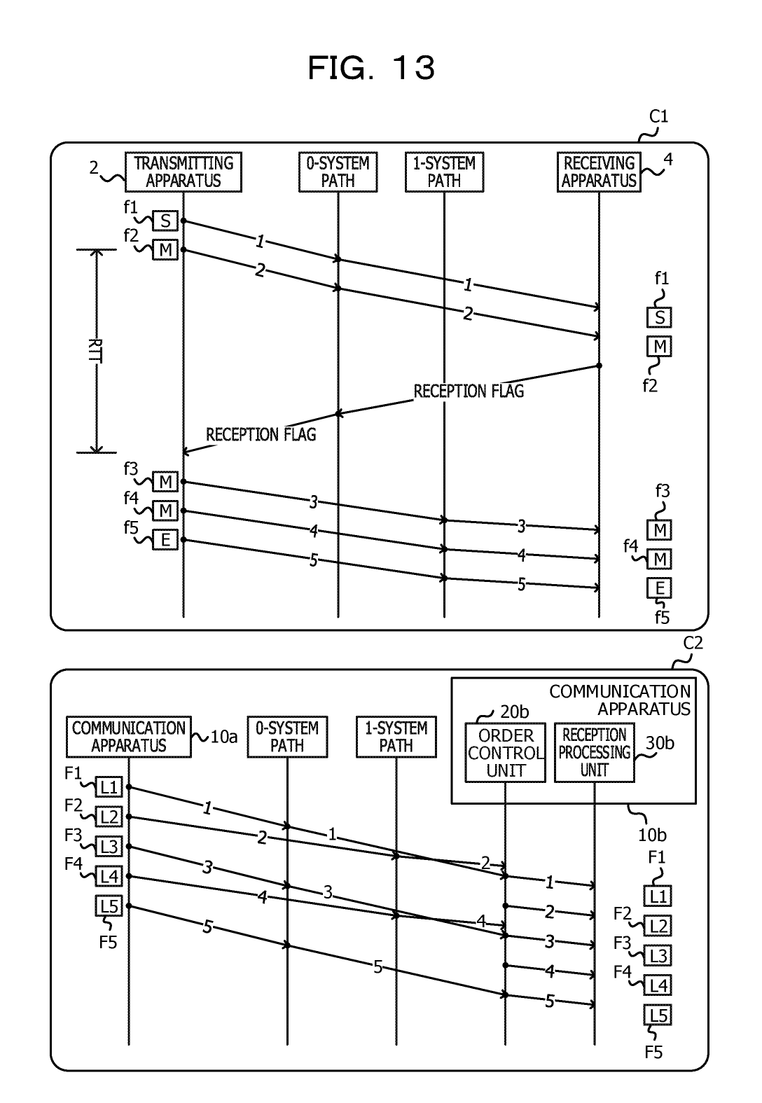

FIG. 13 is a diagram illustrating comparison between the method according to the embodiment and switching processing involving checking the reception status. Case C1 illustrates an example of transmission/reception timings of frames when a transmitting apparatus 2 checks a reception status in a receiving apparatus 4 before switching between paths used for transmission, in order to inhibit occurrence of order reversal. On the other hand, case C2 illustrates transmission/reception timings of frames when the communication apparatus 10a transmits the frames to the communication apparatus 10b by using the method according to the embodiment.

In case C1, after transmitting frames f1 and f2 by using the 0-system path, the transmitting apparatus 2 does not transmit frames through the 1-system path until obtaining, from the receiving apparatus 4, information reporting that the frame f2 is received. After receiving the frame f2, the receiving apparatus 4 transmits, to the transmitting apparatus 2, a frame including a reception flag for reporting that the frame f2 is received. Thus, in case C1, after transmitting the frame f2, the transmitting apparatus 2 suspends transmission of frames until receiving the frame including the reception flag for the frame f2. Accordingly, after transmitting the frame f2, the frame transmission is suspended for a period of time corresponding to a round trip time (RTT) between the transmitting apparatus 2 and the receiving apparatus 4. Consequently, the speed of communication between the transmitting apparatus 2 and the receiving apparatus 4 decreases.

On the other hand, when the method according to the embodiment is used, the communication apparatus 10a adjusts the payload length of a frame in accordance with the order of divided data included in the frame. In addition, the communication apparatus 10b at the receiving end is capable to obtaining the payload length from information in the header. This allows the communication apparatus 10b to control the order of data without reading a payload, as described above with reference to FIGS. 8 to 12 and so on. Thus, even when reversal of the reception order of frames occurs in the communication apparatus 10b at the receiving end, no problem occurs in processing in the communication apparatus 10b. Accordingly, as illustrated in case C2, since the communication apparatus 10a does not check the reception status in the communication apparatus 10b at the receiving end during change of paths used for frame transmission, the frame transmission is not suspended. Accordingly, in case C2 using the method according to the embodiment, the communication speed increases, compared with case C1. Details of communication in case C2 are analogous to those described above with reference to FIG. 12.

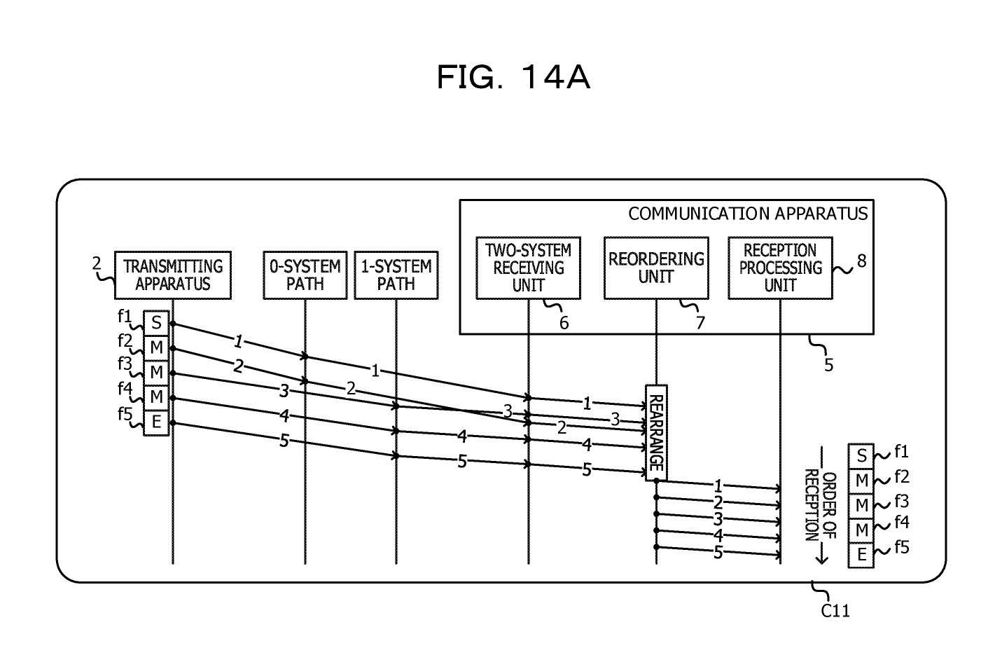

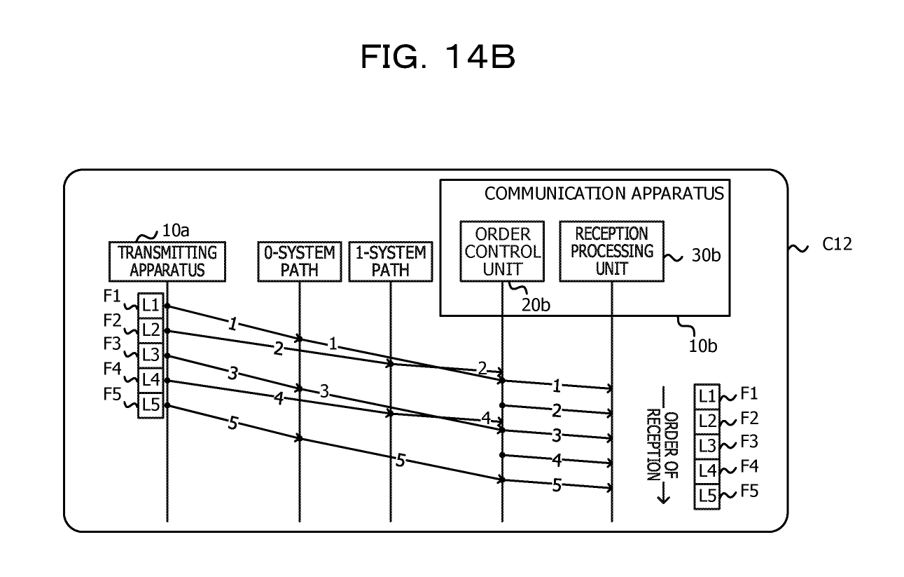

FIGS. 14A and 14B are diagrams illustrating comparison between the method according to the embodiment and a method for performing read processing after performing reordering. Case C11 illustrates an example of the timings of processing frames when read processing is performed after reordering using payloads is performed. On the other hand, case C12 illustrates the timings of transmission/reception and processing of frames when the communication apparatus 10a transmits the frames to the communication apparatus 10b by using the method according to the embodiment.

In case C11, a receiving apparatus 5, which receives frames transmitted from the transmitting apparatus 2, includes a two-system receiving unit 6, a reordering unit 7, and a reception processing unit 8. In this case, the two-system receiving unit 6 performs reception from both the 0-system path and the 1-system path. By using information about the payload in each frame, the reordering unit 7 identifies the order of divided data included in the payload. The reception processing unit 8 processes data output from the reordering unit 7. Thus, in case C11, since the transmitting apparatus 2 does not check the reception state in the receiving apparatus 5 during switching between the 0-system path and the 1-system path, reversal of the order of frames may occur in the receiving apparatus 5. In the example in case C11, the transmitting apparatus 2 transmits frames f1 to f5 in the order f1, f2, f3, f4, and f5. However, the frames f1 to f5 arrive at the receiving apparatus 5 in the order f1, f3, f2, f4, and f5. Accordingly, after the reception of the frames f1 to f5 is finished, the reordering unit 7 changes the order of the frames, based on information about the payloads in the frames, and outputs the frames to the reception processing unit 8 in the order in which the frames f1 to f5 were transmitted. That is, in case C11, data in the received frames are not processed until the reception of all the frames f1 to f5 ends.

On the other hand, when the method according to the embodiment is used, the communication apparatus 10b is capable of identifying the order of pieces of divided data in the frames by using the payload lengths in the frames. Thus, it is possible to control the order of pieces of data without reading the payloads. Accordingly, the amount of processing load on the communication apparatus 10b decreases, compared with a case in which the receiving apparatus 5 performs reordering using the information in the payloads, as illustrated in case C11. In addition, in parallel with receiving the frames, the divided data is output to the reception processing unit 30b in order starting from the front end of data to be transmitted. This allows the communication apparatus 10b to process data in parallel with receiving frames. Details of communication in case C12 are analogous to those described above with reference to FIG. 12.

[Modifications]

The present disclosure is not limited to the above-described embodiment, and various changes are possible thereto. Some examples will be described below.

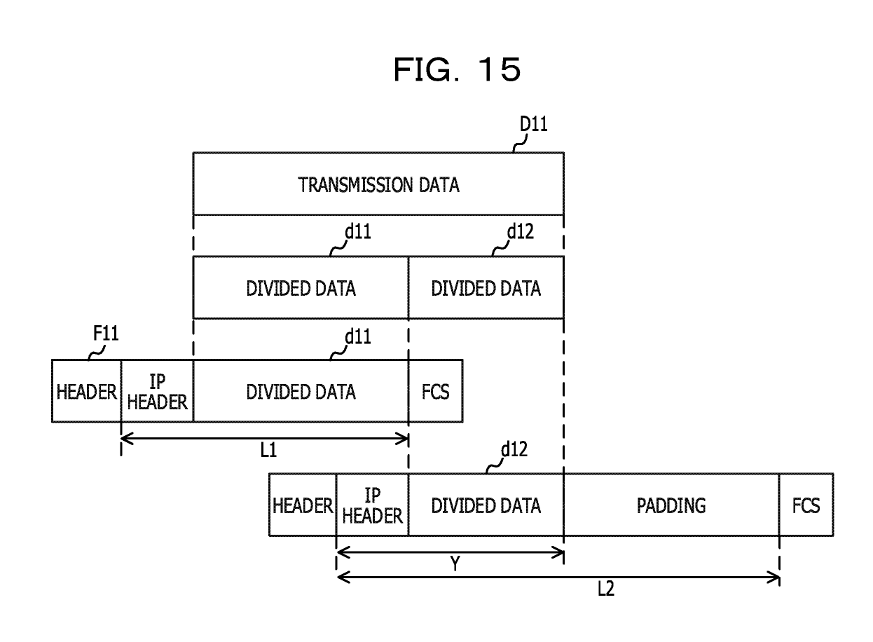

FIG. 15 is a diagram for describing an example when the frame length is adjusted using padding. Even when the calculating unit 51 in the communication apparatus 10 that transmits data calculates payload length in frames, there may be cases in which the total of the calculated payload lengths does not match the total of the data lengths of the transmission data and the lengths of the IP headers corresponding to the number of frames. For example, it is assumed that the calculating unit 51 have calculated the payload lengths of two transmission frames to be L1 and L2. The frame generating unit 52 sets, as divided data d11, data obtained by subtracting the length of an IP header from L1. The frame generating unit 52 adds the IP header to the divided data d11 to obtain a packet having a packet length of L1. The frame generating unit 52 then generates a frame F11 in which a packet having a packet length L1 is a payload.

It is assumed that when data included in the divided data d11 is subtracted from transmission data D11, divided data d12 remains as data that has not been transmitted. It is assumed that the frame generating unit 52 has obtained a packet having a packet length of Y by adding an IP header to the divided data d12. However, it is assumed that the packet length Y is smaller than the payload length L2 in the frame in which the divided data d12 is to be included. In this case, the frame generating unit 52 adds padding subsequent to the packet including the divided data d12 so that the payload length reaches L2. Accordingly, the length of the payload in the frame including the divided data d12 becomes equal to the total of the divided data d12, the IP header, and the padding and thus matches L2. As described above with reference to FIG. 5, the packet length and the header length of the IP packet in a frame are recorded in the IP header in the IP packet. Thus, information indicating that the packet length is Y is recorded in the header of a packet including the divided data d12. The frame generating unit 52 transmits the frame having the payload length L2 via the transmitting unit 11.

When the communication apparatus 10 receives a frame including padding, and the reception processing unit 30 in the communication apparatus 10 at the receiving end processes data, the reception processing unit 30 is capable of separating the packet in the received frame from the padding by using the packet length included in the IP header.

The frame in which the padding is included is not limited to a frame including the last data. For example, although the length of a payload including the third divided data is calculated to be 272 bytes in the case described above with reference to FIG. 6 and so on, an IP packet generated by the frame generating unit 52 is assumed to be 270 bytes. In this case, the frame generating unit 52 adds padding for 2 bytes to the end of the generated IP packet, to thereby generate a frame of 272 bytes. Any data may be included as the padding.

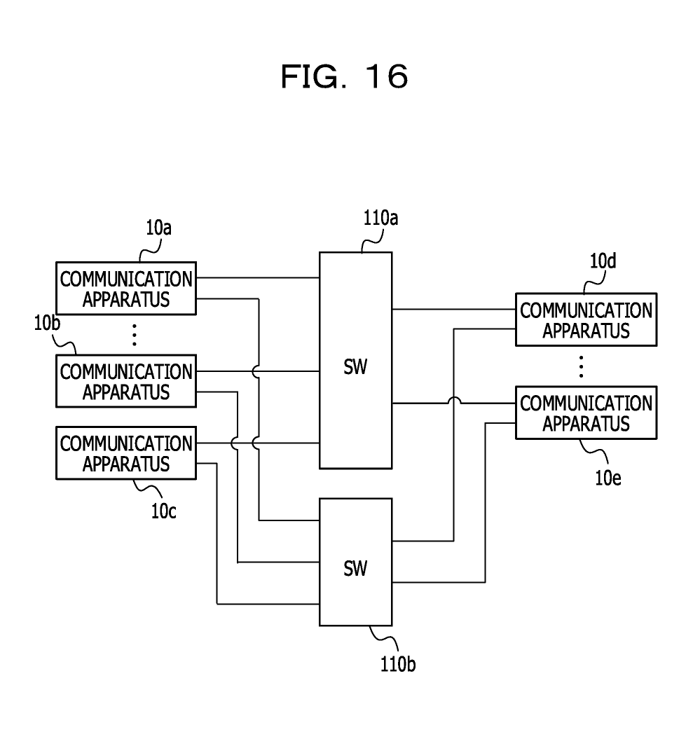

FIG. 16 is a diagram illustrating an example of a system to which the method according to the embodiment is applicable. The above description has been given of an example of a case in which two communication apparatuses 10a and 10b communicate with each other via switch circuits 110a and 110b, as illustrated in FIG. 4. However, the number of communication apparatuses 10 included in the system is arbitrary. For example, in FIG. 16, each of the communication apparatuses 10 (10a to 10e) is connected to both the switch circuits 110a and 110b. In the following description, the switch circuit 110a functions as a 0-system path during communication between the communication apparatuses 10. The switch circuit 110b functions as a 1-system path during communication between the communication apparatuses 10. Each communication apparatus 10 communicates with another communication apparatus 10 by using both the switch circuits 110a and 110b. For example, each communication apparatus 10 may be implemented by a computer or the like. Each communication apparatus 10 may also be implemented by one network interface card (NIC). When each communication apparatus 10 is implemented by a NIC, the entire communication system including the communication apparatuses 10 (10a to 10e) and the switch circuits 110a and 110b may configure one apparatus.

The communication apparatus 10 according to the embodiment performs setting so that the difference between the amount of communication through the 0-system path and the amount of communication through the 1-system path is reduced when each communication apparatus 10 transmits data. Thus, there is an advantage in that a control device for performing load balancing in the entire system may be omitted from the system. Since a control device for performing load balancing is not provided in the system, processing for adding, removing, or modifying the communication apparatus 10 is also simple.

In addition, with the communication method according to the embodiment, the communication apparatus 10 that performs transmission processing is capable of changing a path used for transmission so that the amounts of data to be transmitted become approximately the same in individual paths used for communication. For example, the communication apparatus 10 that performs transmission processing may alternately change paths used to transmit frames. The paths may also be changed for every predetermined number of frames. In addition, the communication apparatus 10 that performs transmission processing may use the number of bytes of transmission data, not the number of frames, to determine the timing of switching between paths used for transmission processing.

The division condition information 41 used in the above description is an example. The division condition information 41 may be changed depending on an implementation.

The above description has been given of an example in which the calculating unit 51 pre-holds a numerical value that the calculating unit 51 uses as a reference for determining the division number. However, depending on traffic, the calculating unit 51 may change the reference value used to determine the division number. For example, in a system in which the size of data to be transmitted/received is relatively small, the calculating unit 51 reduces the reference value to a relatively small value. Also, in a system in which the size of data to be transmitted/received is relatively large, the calculating unit 51 increases the reference value to a relatively large value. In addition, based on an average size of transmission data, the calculating unit 51 may determine the reference value so that data of the average size is dividable into a plurality of pieces of divided data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A data-division control method executed by a communication system including a first communication apparatus and a second communication apparatus coupled with the first communication apparatus through a first path and a second path, the data-division control method comprising:
generating, by a first processor included in the first communication apparatus, a plurality of divided data by dividing transmission data to be transmitted;
generating a plurality frames including the plurality of divided data by adjusting a length of a payload in which each of the plurality of divided data is stored, in accordance with condition information in which payload lengths and an order of divided data are associated with each other, each of the first communication apparatus and the second communication apparatus including a memory configured to store the condition information;
transmitting the plurality of frames to the second communication apparatus by using the first path and the second path;
extracting, by a second processor included in the second communication apparatus, information about a payload length from a header of each of the plurality of frames; and
identifying an order of the plurality of divided data included in the plurality of frames, by using the extracted information about the payload length and the condition information that is stored in the memory included in the second communication apparatus.

2. The data-division control method according to claim 1, further comprising:
determining, by the second communication apparatus, whether divided data corresponding to the order of the plurality of divided data is received according to the order; and
processing the divided data in a frame of interest which is to be subjected to reception processing, when all of the plurality of frames are not received and un-received divided data associated with an order that is earlier than the order of the divided data included in the frame of interest is not found.

3. The data-division control method according to claim 2, further comprising:
delaying, by the second communication apparatus, processing on the divided data in the frame of interest until receiving the un-received divided data, when the un-received divided data associated with the order that is earlier than the order of the divided data included in the frame of interest is found.

4. The data-division control method according to claim 1, further comprising:
selecting, by the first communication apparatus, a path used for transmitting each of the plurality of frames from the first path and the second path so that a difference between an amount of data to be transmitted to the second communication apparatus through the first path and an amount of data to be transmitted to the second communication apparatus through the second path is reduced.

5. The data-division control method according to claim 1, further comprising:
determining, by the first processor, a division number for the transmission data, based on the condition information.

6. The data-division control method according to claim 1,
wherein the generating the plurality of frames includes storing information about the adjusted payload length in the header of each of the plurality of frames.

7. The data-division control method according to claim 1,
wherein each of the plurality of frames further includes other information different from the transmission data.

8. A communication system comprising:
a first communication apparatus including a first processor; and
a second communication apparatus including a second processor,
wherein the first processor is configured to:
generate plurality of divided data by dividing transmission data to be transmitted;
generate a plurality frames including the plurality of divided data by adjusting a length of a payload in which each of the plurality of divided data is stored, in accordance with condition information in which payload lengths and an order of divided data are associated with each other, each of the first communication apparatus and the second communication apparatus including a memory configured to store the condition information; and
transmit the plurality of generated frames to the second communication apparatus, and
wherein the second processor is configured to:
extract information about a payload length from a header of each of the plurality of frames; and
identify an order of the plurality of divided data included in the plurality of frames, by using the extracted information about the payload length and the condition information that is stored in the memory included in the second communication apparatus.

9. The communication system according to claim 8, wherein the second processor is configured to:
determine whether divided data corresponding to the order of the plurality of divided data is received according to the order; and
process the divided data in a frame of interest which is to be subjected to reception processing, when all of the plurality of frames are not received and un-received divided data associated with an order that is earlier than the order of the divided data included in the frame of interest is not found.

10. The communication system according to claim 9, wherein the second processor is configured to
delay processing on the divided data in the frame of interest until receiving the un-received divided data, when the un-received divided data associated with the order that is earlier than the order of the divided data included in the frame of interest is found.

11. The communication system according to claim 8, wherein the first processor is configured to
select a path used for transmitting each of the plurality of frames from the first path and the second path so that a difference between an amount of data to be transmitted to the second communication apparatus through the first path and an amount of data to be transmitted to the second communication apparatus through the second path is reduced.

12. A communication apparatus, comprising
a memory; and
a processor coupled to the memory and configured to:
receive a plurality of frames including a plurality of divided data obtained by dividing transmission data, a length of a payload that is included in each of the plurality of frames and in which corresponding divided data is stored being adjusted in accordance with condition information in which payload lengths and an order of divided data are associated with each other;
extract information about a payload length from a header of each of the plurality of frames; and
identify an order of the plurality of divided data included in the plurality of frames, by using the extracted information about the payload length and the condition information.
